(19) United States
(12) Patent Application Publication
(10) Pub. No.: US 2025/0350921 A1
(43) Pub. Date: Nov. 13, 2025

(54) SYSTEMS AND METHODS FOR ON-DEMAND eSIM ACTIVATION

(71) Applicant: Verizon Patent and Licensing Inc., Basking Ridge, NJ (US)

(72) Inventors: Madhan Muralimanohar, Tampa, FL (US); Nidhi Bhardwaj, Alpharetta, GA (US); Deepak Rao, Cumming, GA (US); Arun Kumar Yelimeli Guruprasad, Alpharetta, GA (US)

(21) Appl. No.: 18/658,101

(22) Filed: May 8, 2024

(51) Int. Cl. H04W 8/18; H04L 41/0806; H04W 8/26

(52) U.S. Cl. CPC H04W 8/183; H04L 41/0806; H04W 8/26

(57) ABSTRACT

Systems and methods provide an on-demand embedded subscriber identity module (eSIM) activation function that expedites the activation and provisioning process for user equipment (UE) devices. A network device receives, from a UE device, an activation request for an eSIM and detects, in the activation request, an activation parameter. In response to detecting that the activation parameter includes an on-demand activation indicator, the network device routes the activation request to an on-demand activation function, and initiates provisioning of basic wireless features for the UE device without receiving a provisioning request from the UE device.

### BACKGROUND

Mobile devices with embedded subscriber identity modules (eSIMs) may be a practical alternative to traditional SIMs (i.e., removable SIM cards) containing subscription credentials. While providing a comparable level of security and many design advantages over the removable SIM, eSIM technology presents a user experience distinct to that of using a SIM card with respect to activating user equipment (UE) devices for use on a mobile network operator (MNO) network. As new models of UE devices continue to be released, more manufacturers are opting to use only eSIMs, resulting in increasing volumes of eSIM activation requests.

### BRIEF DESCRIPTION OF THE DRAWINGS

FIG. 1 is a diagram illustrating an example network environment consistent with an embodiment described herein;

FIG. 2 is a block diagram illustrating an embedded subscriber identity module (eSIM) activation framework in a portion of a network environment, according to an implementation;

FIG. 3 is a block diagram showing logical components of an eSIM activation function;

FIG. 4 is a block diagram showing logical components of an on-demand eSIM activation function;

FIGS. 5 and 6 are signal flow diagrams illustrating communications for eSIM activation in a portion of a network environment;

FIG. 7 is a block diagram showing logical components of a request route handler;

FIG. 8 is a flow chart of an exemplary process for on-demand eSIM activation; and

FIG. 9 is a block diagram illustrating example components of a device that may correspond to one or more of the devices described herein.

### DETAILED DESCRIPTION

The following detailed description refers to the accompanying drawings. The same reference numbers in different drawings may identify the same or similar elements. The following detailed description does not limit the scope of the invention.

The eSIM offers MNOs, UE distributors, UE manufacturers, and UE users, benefits not afforded by traditional SIM technology (i.e., physical SIM cards). For example, eSIM-enabled devices—without a SIM card slot—provide a more compact design and are available to additional classes of UE devices (e.g., wearables). In addition, UE supply chain processes may be optimized, and the need for customization of UE devices for specific MNOs and/or operating regions may be eliminated. Furthermore, eSIM technology may provide for simplified subscription management, for example, when activating UE devices or changing MNOs.

One challenge specific to SIM technology involves initial cellular service activation without an active SIM profile. For example, a user typically needs to activate a UE device obtained from an MNO, distributor, or retailer, and may need to remotely activate the UE device to enable service on the MNO's cellular network. To activate the UE device a designated SIM profile is downloaded to the UE device from a remote SIM provisioning (RSP) system, and the MNO may then provision a network service using the designated SIM profile.

Activation and provisioning for an eSIM may involve installation of a client application (referred to herein as an ordering client) on the UE device by using an activation voucher/code (e.g., a quick response (QR) code contained in printed material, a display at a point of sale, an email, etc.) that contains the network address (e.g., a fully qualified domain name (FQDN)) of the MNO's remote SIM provisioning system. Alternatively, activation may involve preloading of an MNO-specific application or an MNO-specific entitlement server address on the UE device by the UE manufacturer.

Currently, using an industry standard queuing mechanism, eSIM activation requests are received by an MNO's activation platform and activated in the order received from the ordering client. Industry standards (e.g., Global System for Mobile Communications Association (GSMA) standards) define interface specifications for eSIM activation, whereas a framework for eSIM activation is MNO-specific. The ordering client is used to initiate a provisioning process after eSIM activation, ensuring the eSIM is fully activated prior to feature/service provisioning for better security. Delays may be incurred with multiple signaling round trips to the ordering client. In some cases, such delays may not be relevant to the customer experience, such as when a UE device is ordered through the mail. In other cases, the delays may be disruptive, such as during an in-store UE device purchase/activation.

With many mobile device manufacturers now implementing eSIMs exclusively for new equipment, activation delays are increasingly impacting the customer experience. A typical eSIM activation process can exceed 10 minutes. Thus, expediting the eSIM activation process is necessary for an improved customer experience. According to implementations described herein, times for the eSIM activation process can be reduced significantly (e.g., to less than one minute).

Systems and methods described herein provide an eSIM activation framework that can expedite the activation and provisioning process for UE devices. In one implementation, an on-demand eSIM activation function can be used in conjunction with standard activation logic depending on a particular customer environment. Decision logic in the eSIM activation framework is provided to route an activation request to an appropriate activation function (i.e., standard activation or on-demand activation) based on, for example, a key indicator. The key indicator may be provided by a UE scanning system/partner, such as warehouse scanning for shipment or store point-of-sale scanning for in-store ordering, and included as part of the activation request.

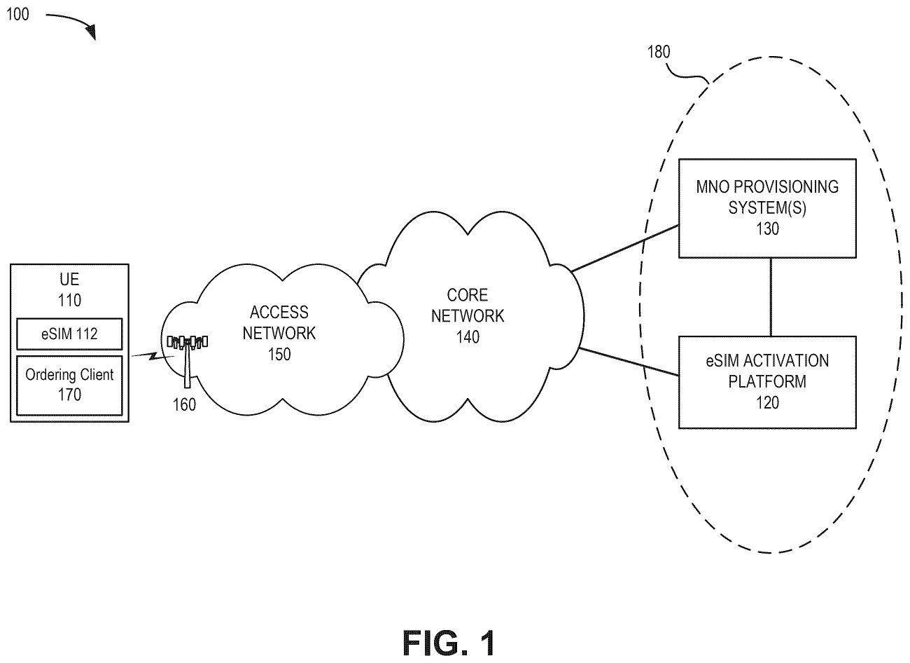

FIG. 1 is a diagram of an exemplary environment 100 in which the systems and/or methods, described herein, may be implemented. As shown in FIG. 1, environment 100 may include a UE device 110 (or UE 110), an eSIM activation platform 120, an MNO provisioning system 130, a core network 140, and an access network 150. UE device 110 may include an eSIM 112 and an ordering client 170, as described further herein. The elements shown within area 180 (i.e., eSIM activation platform120 and MNO provisioning system 130) may be associated with an MNO that provides wireless services to UE device 110. The elements shown within area 180 may also be interconnected via an internal company network, such as a local area network (LAN) or wide area network (WAN), that includes wired, wireless and/or optical connections between the elements illustrated in FIG. 1. In other implementations, the devices illustrated within area 180 may be directly or indirectly coupled to each other via an external network, such as the Internet. In some embodiments, area 180 may include a core network associated with an MNO.

UE 110 may include any device with long-range (e.g., cellular or mobile wireless network) wireless communication functionality. For example, UE 110 may include a handheld wireless communication device (e.g., a mobile phone, a smart phone, a tablet device, etc.); a Fixed Wireless Access (FWA) device; a Customer Premises Equipment (CPE) device with Fourth Generation (4G) and Fifth Generation (5G) capabilities; a tablet device; a wearable computer device (e.g., a smart watch); a global positioning system (GPS) device; a laptop computer; a media playing device; a portable gaming system; an autonomous vehicle navigation system; a sensor; an Internet-of-Things (IoT) device; and/or any other type of computer device with wireless communication capabilities and a user interface. In some implementations, UE 110 may include a wireless Machine-Type-Communication (MTC) device that communicates with other devices over a machine-to-machine (M2M) interface, such as Category M1 (CAT-M1) devices and Narrow Band (NB)-IoT devices. UE 110 may also be referred to herein as a user device, a mobile device, or an SIM-enabled device.

UE 110 may include eSIM 112, which may be implemented as an embedded Universal Integrated Circuit Card (eUICC), that allows UE 110 to wirelessly access an MNO communication network. In some embodiments, eSIM 112 may be directly embedded or hardwired into UE 110. eSIM 212 may store SIM profiles, also referred to as Integrated Circuit Card Identifiers (ICCIDs). A SIM profile may store MNO and subscriber data, such as a user's subscription credentials, network settings, and/or SIM-based applications, and allow UE 110 and/or the user to connect to the wireless MNO network.

As shown in FIG. 1, UE 110 may include an ordering client 170. Ordering client 170 may include logic associated with interfacing with eSIM 112 to activate UE 110. Ordering client 170 may interface with eSIM activation platform 120 to activate existing SIM profiles or download and activate a new SIM profile to eSIM 112. Ordering client 170 may provide an activation request, to eSIM activation platform 120, that indicates whether standard or on-demand eSIM activation is needed (e.g., via providing a key indicator). In some instances, ordering client 170 may also initiate network provisioning of some or all services needed for a new eSIM profile.

eSIM activation platform 120 may include one or more network devices to manage activation of cellular devices on the MNO's network. eSIM activation platform 120 may parse incoming eSIM activation requests and route requests through either a standard eSIM activation function or an on-demand eSIM activation function. The on-demand eSIM activation function may expedite an activation process and trigger a provisioning process in real time to reduce delays and improve a customer experience.

MNO provisioning system 130 may include one or more network devices or systems that act as a backend for a wireless network to facilitate operations of the wireless network. MNO provisioning system 130 may configure network elements (e.g., core network elements, radio access network (RAN) elements, etc.) to support services for a new eSIM profile. MNO provisioning system 130 may support either the standard eSIM activation function or the on-demand eSIM activation function of eSIM activation platform 120. For standard eSIM activation, MNO provisioning system 130 may receive a provisioning trigger from an ordering client 170 of UE device 110. For on-demand eSIM activation, MNO provisioning system 130 may receive a provisioning trigger from the on-demand eSIM function as well as other information from ordering client 170.

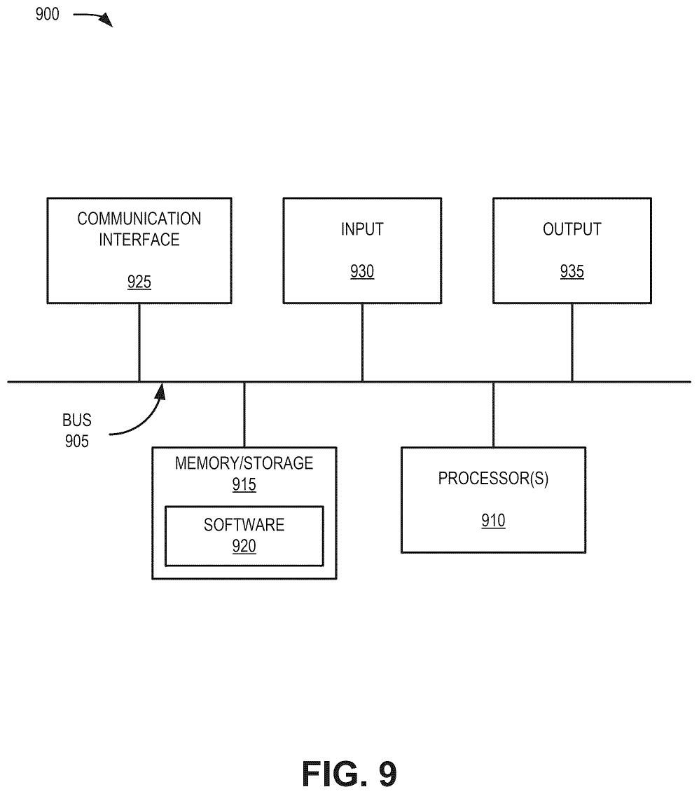

Core network 140 may oversee communication sessions for subscribers connecting via access network 150. The components within core network 140 can be either dedicated hardware elements or virtualized functions operating atop a shared physical infrastructure using Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 900, as described below with reference to FIG. 9, within a cloud computing center associated with core network 140. Moreover, core network 140 may encompass 5G core network components, 4G core network components, and/or other types of components.

Access network 150 may include a RAN to facilitate UE 110's connection to core network 140 by establishing and managing over-the-air channels with UE 110 and backhaul channels with core network 140. These channels enable the relay of information between UE 110 and core network 140. Access network 150 comprises Long-Term Evolution (LTE), 5G New Radio (NR), or other advanced radio access networks, featuring components such as central units (CUs), distributed units (DUs), radio units (RUs), and/or base stations. These network components are illustrated in FIG. 1 as access stations 160 for establishing and maintaining over-the-air channel with UEs 110. In some implementations, access station 160 may include a 4G, 5G, or another type of base station (e.g., eNB, gNB, etc.) that comprises one or more radio frequency (RF) transceivers. In some implementations, access station 160 may be part of an evolved Universal Mobile Telecommunications Service (UMTS) Terrestrial Radio Access Network (eUTRAN).

As used herein, the term “user” is intended to be broadly interpreted to include UE 110 and/or a person using UE 110. Also, the terms “user,” “operator,” “subscriber,” and/or “customer” are intended to be used interchangeably. The number of devices and/or networks illustrated in FIG. 1 is provided for explanatory purposes only. In practice, additional devices and/or networks, fewer devices and/or networks, different devices and/or networks, or differently arranged devices and/or networks than those illustrated in FIG. 1 may be used. Also, in some implementations, one or more of the components or networks may perform one or more functions described as being performed by another one or more of the other components or networks. The components and networks shown in FIG. 1 may be interconnected via wired connections, wireless connections, or a combination of wired and wireless connections.

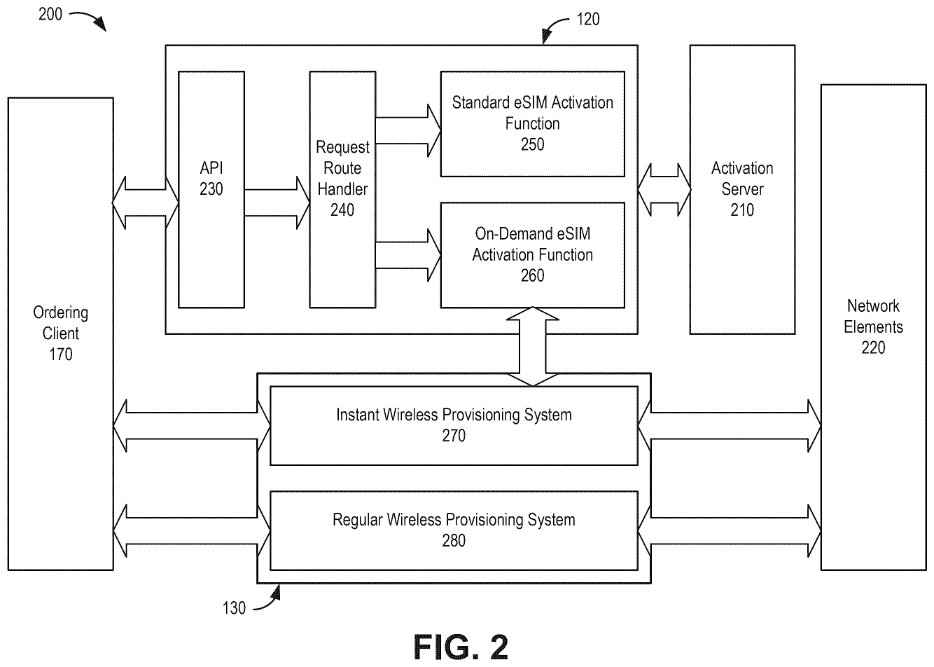

FIG. 2 is a block diagram illustrating an eSIM activation framework in a portion 200 of network environment 100. Network portion 200 may include eSIM activation platform 120, MNO provisioning system 130, ordering client 170, an activation server 210, and network elements 220.

The eSIM activation platform 120 may include application programming interface (API) 230, a request route handler 240, a standard eSIM activation function 250, and an on-demand eSIM activation function 260. API 230 may include APIs for eSIM activation. In one implementation, an activation request may utilize a direct interfacing API that eliminates a queuing mechanism that may typically be associated with processing of eSIM activation requests. For example, the API may support use of a key indicator (also referred to an activation-type indicator) that may allow request route handler 240 to determine whether or not an activation request is time-sensitive (e.g., requiring on-demand eSIM activation). In another implementation, eSIM activation platform 120 may support on-demand activation requests from ordering client 170 without changes to standardized APIs or GSMA interface specifications for eSIM activation.

Request route handler 240 may provide a routing decision function to direct activation requests from ordering client 170/UE 110 to one of standard eSIM activation function 250 or on-demand eSIM activation function 260 within eSIM activation platform 120. Request route handler 240 may select standard eSIM activation function 250 or on-demand eSIM activation function 260, for example, to avoid overloading on-demand eSIM activation function 260 for the requests that are not time-sensitive. According to an implementation, an activation request from ordering client 170 may include a key indicator that may allow request route handler 240 to determine whether an activation is time-sensitive (e.g., requiring on-demand eSIM activation). For example, ordering client 170 may indicate a point of origin for an activation request. Request route handler 240 may determine, for example, to route an activation request with an in-store point of origin (e.g., where a customer may be waiting with a sales associate) to on-demand activation. Conversely, request route handler 240 may determine, for example, to route an activation request for standard eSIM activation when a UE device is being shipped to a residence.

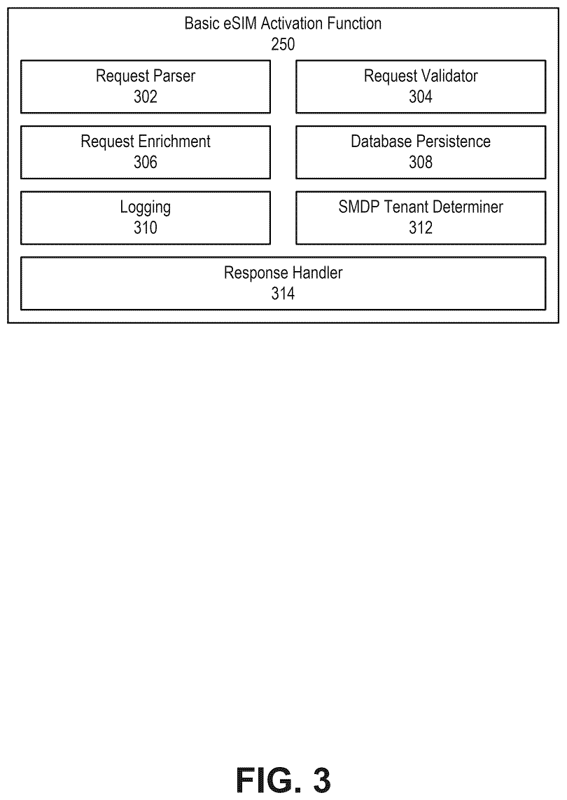

Standard eSIM activation function 250 may follow an existing activation sequence, where eSIM activation requests are received and activated in the order received from different ordering clients 170. A first-in first-out queue may be a source of activation delays, which may be acceptable when the activation delays are not impacting the customer experience. After eSIM activation, the ordering client 170 initiates a provisioning process for network elements 220. Standard eSIM activation function 250 is described further in connection with FIG. 3.

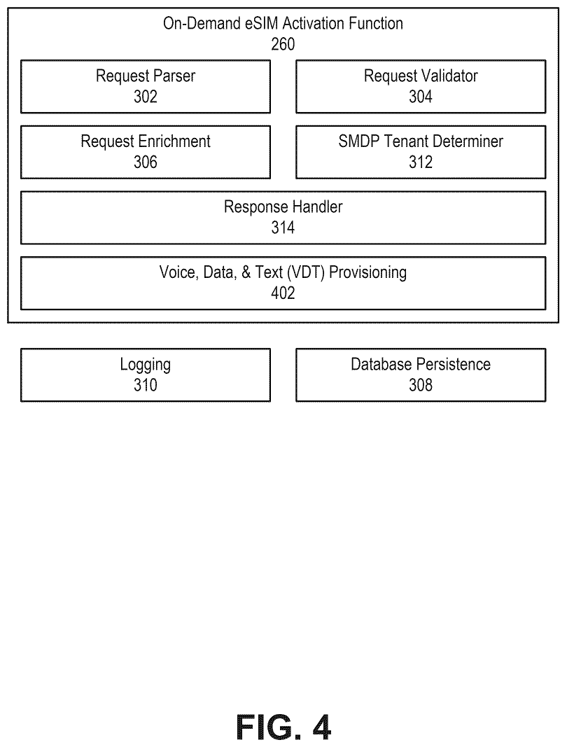

On-demand eSIM activation function 260 may include logic to instantly or more quickly provision wireless service for the UE device 110 before activating the eSIM on-demand. In contrast with standard eSIM activation, on-demand eSIM activation function 260 eliminates the first-in first-out queue and implements real-time synchronous APIs to handle an eSIM activation request. On-demand eSIM activation function 260 may instantly provision basic wireless features (voice, data, and text) in core network 140, instead of waiting for ordering client 170 to initiate a provisioning process. Additionally, in one implementation, on-demand eSIM activation function 260 may initiate provisioning of basic wireless features without queuing of a provisioning request. The on-demand eSIM activation function 260 may perform activation in a network device (e.g., one of devices 900 described below) without any overhead of internal data processing logic, such as database persistence and logging functions, using a secured, scalable and reliable interface. On-demand eSIM activation function 260 is described further in connection with FIG. 4.

Activation server 210 may assign eSIM profiles based on, for example, on subscriptions associated with customers. Activation server 210 may communicate with one or more other network devices (not shown) to authenticate an activation request and generate an eSIM profile to associate with UE device 110. Activation server 210 may receive requests from eSIM activation platform 120 and provide responses/profiles to eSIM activation platform 120.

Network elements 220 may include dedicated hardware and/or software elements or virtualized functions that provide features for UE 110. Network elements 220 may include, for example, functions of core network 140, access network 150, or other networks related to an MNO. Network elements 220 may receive provisioning instructions from MNO provisioning system 130, for example, when an eSIM is activated on core network 140. Provisioning information for network elements 220 may include a subscriber profile for UE 110, such as data limits, service types, home/default service functions, etc.

As further shown in FIG. 2, MNO provisioning system 130 may include an instant wireless provisioning system 270 and a regular wireless provisioning system 280. Instant wireless provisioning system 270 may communicate with on-demand eSIM activation function 260 to provision basic wireless features (i.e., voice, data, and text) on network elements 220 in core network 140. According to an implementation, instant provisioning system 270 may receive signals from on-demand eSIM activation function 260 to initiate provisioning of the basic wireless features during the eSIM activation process and without waiting for ordering client 170 to initiate the provisioning. Regular wireless provisioning system 280 may perform conventional provisioning based on direction from ordering client 170 when standard eSIM activation function 250 is used. In another implementation, one of instant wireless provisioning system 270 or regular wireless provisioning system 280 may also perform provisioning of additional features (e.g., other than voice, data, and text) that were not part of the instant activation process initiated by on-demand eSIM activation function 260.

FIG. 3 is a block diagram showing logical components of standard eSIM activation function 250. As shown in FIG. 3, standard eSIM activation function 250 may include a request parser 302, a request validator 304, request enrichment logic 306, database persistence logic 308, logging 310, a Subscription Manager-Data Preparation (SMDP) tenant determiner 312, and a response handler 314. Activation request routed to standard eSIM activation function 250 may generally follow a sequential process through each of request parser 302, request validator 304, request enrichment logic 306, database persistence logic 308, logging 310, SMDP tenant determiner 312, and response handler 314, as described below.

Standard eSIM activation function 250 may include a combination of activation logic (e.g., that relates directly to processing an activation request) and internal data processing (e.g., that creates records of transactions). Request parser 302 may receive a request and analyze the request to determine that type of request (e.g., an eSIM activation request). Request validator 304 may review the activation request for errors. Request enrichment logic 306 may perform data enrichment to connect or associate the request to additional data/subscriber information. Database persistence logic 308 may persist or store the activation request on a local storage by writing to a drive either on which database persistence logic 308 has mounted a physical volume or to a database provided for database persistence logic 308. Logging 310 may generate an audit log for transactions, such as a record of an activation request, a response to the activation request, and any intervening processes for the activation request. SMDP tenant determiner 312 may identify an entity or enterprise for the activation request. For example, SMDP tenant determiner 312 may distinguish between a request for an MNO or a mobile virtual network operator (MVNO) that uses a network of the MNO. Response handler 314 may manage delivery of responses and/or confirmation messages to ordering client 170.

FIG. 4 is a block diagram showing logical components of on-demand eSIM activation function 260. As shown in FIG. 4, on-demand eSIM activation function 260 may include request parser 302, a request validator 304, request enrichment logic 306, SMDP tenant determiner 312, response handler 314, and Voice, Data, and Text (VDT) provisioning logic 402.

In on-demand eSIM activation function 260, functions of request parser 302, request validator 304, request enrichment logic 306, SMDP tenant determiner 312, and response handler 314 may be consistent with those described above for standard eSIM activation function 250. In contrast with standard eSIM activation function 250, an activation request routed to on-demand eSIM activation function 260 may separate activation logic (e.g., that relates directly to processing an activation request) from internal data processing (e.g., that creates records of transactions). Thus, database persistence logic 308 and logging 310 may not be included directly in the activation process for on-demand eSIM activation function 260.

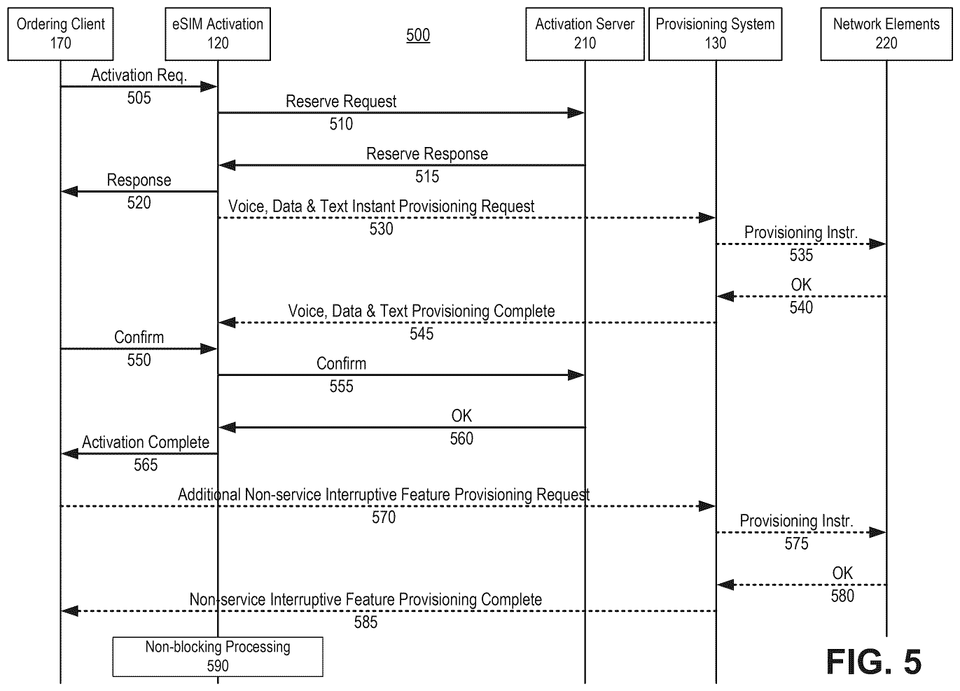

VDT provisioning logic 402 may include internal logic to trigger provisioning of basic wireless features (i.e., voice, data, and text) without waiting for a separate request from ordering client 170. VDT provisioning logic 402 may have a communication link (e.g., an API or another signaling interface) to initiate provisioning of VDT service by instant wireless provisioning system 270. As described further in connection with FIG. 5, for example, VDT provisioning logic 402 may provide a VDT provisioning request to instant wireless provisioning system 270 after receiving an initial response from activation server 210. Thus, provisioning of network elements 220 (for VDT) may be performed concurrently with confirmation procedures for the eSIM activation sequence.

As further shown in FIG. 4, logging 310 and database persistence logic 308 are provided outside of on-demand eSIM activation function 260. Thus, data persistence and auditing log entry are removed from the activation call flow path and conducted as non-blocking or parallel processes. That is, the activation of features does not require waiting for confirmation or logging functions.

FIG. 5 is a signal flow diagram illustrating communications in a portion 500 of network environment 100. More particularly, communications in FIG. 5 represent communications for on-demand eSIM activation. Network portion 500 may include ordering client 170, eSIM activation platform 120, MNO provisioning system 130, activation sever 210, and network elements 220. FIG. 5 provides simplified illustrations of communications in network portion 500 and is not intended to reflect every signal or communication exchanged between devices. Signals shown with solid lines indicate eSIM activation signaling, while signals shown with dashed lines indicate network provisioning signals.

Ordering client 170 may submit to eSIM activation platform 120 an activation request 505 to reserve an eSIM profile for a subscriber/UE device 110. Activation request 505 may include, among other information, a key indicator for on-demand activation. For example, in one implementation, activation request 505 may include (a) an eUICC identifier, (b) a FQDN, (c) a location code, and/or (d) a Boolean activation-type indicator. In the example, of FIG. 5, the activation-type indicator may be detected by request route handler 240 (not shown in FIG. 5) of eSIM activation platform 120 and cause activation request 505 to be directed through on-demand eSIM activation function 260 (also not shown) of eSIM activation platform 120.

In response to activation request 505, eSIM activation platform 120 may perform on-demand activation processing and provide a reserve request 510 to activation server 210. Activation server 210 may receive reserve request 510 and reserve an eSIM profile for UE device 110. Activation server 210 may provide a reserve response 515, including data for the reserved eSIM profile, back to eSIM activation platform 120, which may in turn provide a response 520 (e.g., including confirmation code) to ordering client 170 with a request for a confirmation.

As shown in FIG. 5, eSIM activation platform 120 may initiate provisioning of basic services without waiting for the confirmation from ordering client 170. For example, eSIM activation platform 120 may provide a VDT provisioning request 530 to provisioning system 130. Provisioning system 130 may receive provisioning request 530 and provide provisioning instructions 535 to the various network elements 220 (e.g., a Unified Data Management (UDM) function, a Charging Function (CHF), a Telephony Application Server (TAS), a Short Message Service Function (SMSF)/Short Message Service Center (SMSC), etc.) to support the new eSIM activation. Network elements 220 may perform the provisioning and provide an indication (i.e., OK 540) to provisioning system 130 when the provisioning of each network element 220 is performed. Provisioning system 130 may then provide a signal (i.e., VDT provisioning complete message 545) to eSIM activation platform 120 that VDT provisioning is complete.

Concurrently with or after the network provisioning steps of 530-545, ordering client 170 may provide a confirmation (i.e., confirm message 550) to eSIM activation platform 120. In one implementation, confirm message 550 may include a confirmation code or another authentication mechanism submitted by a user. eSIM activation platform 120 may forward the confirmation (i.e., confirm message 555) to activation server 210 and, in response, may receive an indication (i.e., OK message 560) that the confirmation code is valid/accepted by activation server 210.

Upon receiving both VDT provisioning complete message 545 and OK message 560, eSIM activation platform 120 may provide to ordering client 170 an eSIM activation confirmation message (i.e., eSIM and basic service activation complete message 565) indicating the eSIM and basic service activation are complete. After receiving message 565, a user may perform basic wireless communication functions via UE 110, such as place/accept a voice call, send/receive text messages, or initiate a data session.

Furthermore, in response to message 565, ordering client 170 may send an additional non-service interruptive feature provisioning request 570 to provisioning system 130. Provisioning request 570 may initiate provisioning of non-basic services (i.e., other than VDT services) that can be provisioned, for example, during the subsequent few seconds (e.g., typically less than a minute) after initial eSIM activation. The non-basic services may include, for example, voicemail services, call forwarding services, and the like, which may not typically be utilized in the initial few minutes of a newly activated wireless subscription. Provisioning system 130 may receive provisioning request 570 and provide provisioning instructions 575 to the various network elements 220 to support the new eSIM activation for the non-basic services. Network elements 220 may perform the provisioning and provide an indication (i.e., OK 580) to provisioning system 130 when the provisioning of each network element 220 is performed. Provisioning system 130 may then provide a signal (i.e., non-service interruptive feature provisioning complete message 585) to ordering client 170 that VDT provisioning is complete.

As further shown in FIG. 5, eSIM activation platform 120 may perform internal data processing as non-blocking processing 590. Non-blocking processing 590 may be performed in parallel with or after other activation signals (e.g., signals 510-585) without delaying/impacting the other activation signals. For example, eSIM activation platform 120 may perform logging and database updates related to reserve requests (e.g., reserve request 510) and confirmations (e.g., confirm message 555) after non-basic service processing has been performed, which results in more efficient service activation.

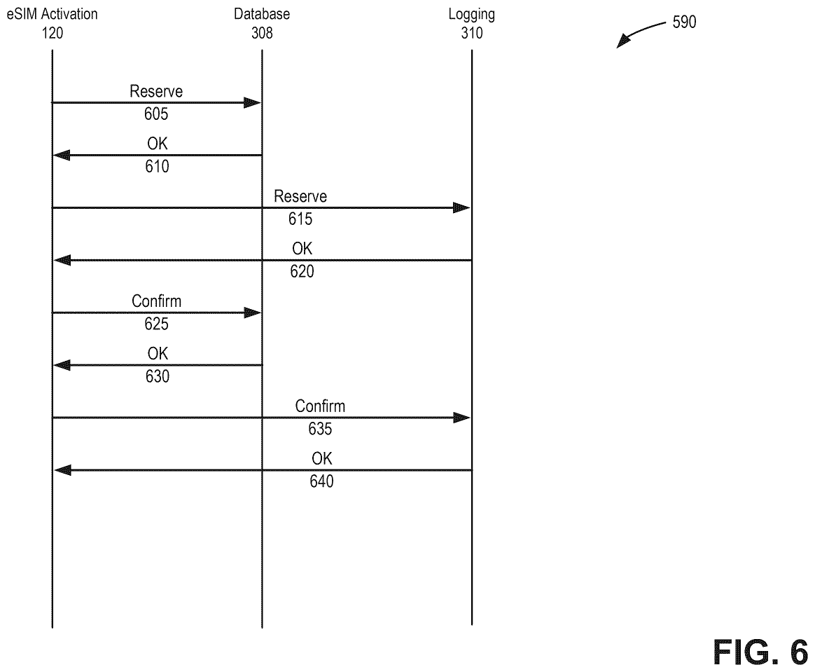

FIG. 6 is a diagram showing signals of non-blocking processing 590. As shown in FIG. 6, eSIM activation platform 120 may provide data from a reserve request 605 (e.g., reserve request 510 data) to database persistence logic 308 and receive an acknowledgement message 610. Also, eSIM activation platform 120 may provide a record of a reserve request 615 (e.g., a record of reserve request 510) to logging 310 and receive an acknowledgement message 620. Similarly, eSIM activation platform 120 may provide data from a confirm message 625 (e.g., confirm message 555 data) to database persistence logic 308 and receive an acknowledgement message 630. Also, eSIM activation platform 120 may provide a record of a confirm message 635 (e.g., a record of confirm message 625) to logging 310 and receive an acknowledgement message 640.

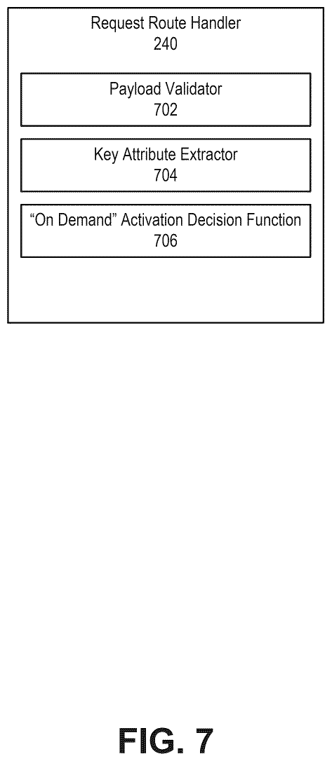

FIG. 7 is a block diagram showing logical components of request route handler 240. As shown in FIG. 7, request route handler 240 may include a payload validator 702, a key attribute extractor 704, and an on-demand activation decision function 706.

Payload validator 702 may verify the structure and/or data of a payload in an activation request. For example, payload validator 702 may check that a structure is consistent with an expected request structure and includes necessary fields. In one implementation, payload validator may confirm that a request includes an eUICC identifier, a FQDN, a location code, and a Boolean activation-type indicator. Key attribute extractor 704 may identify and extract from an activation request (e.g., activation request 505) a key attribute, such as the Boolean activation-type indicator for on-demand activation. On-demand activation decision function 706 may read an activation-type indicator and determine a value (e.g., true or false). On-demand activation decision function 706 may route an activation request to standard eSIM activation function 250 or on-demand eSIM activation function 260 based on the value of the Boolean activation-type indicator.

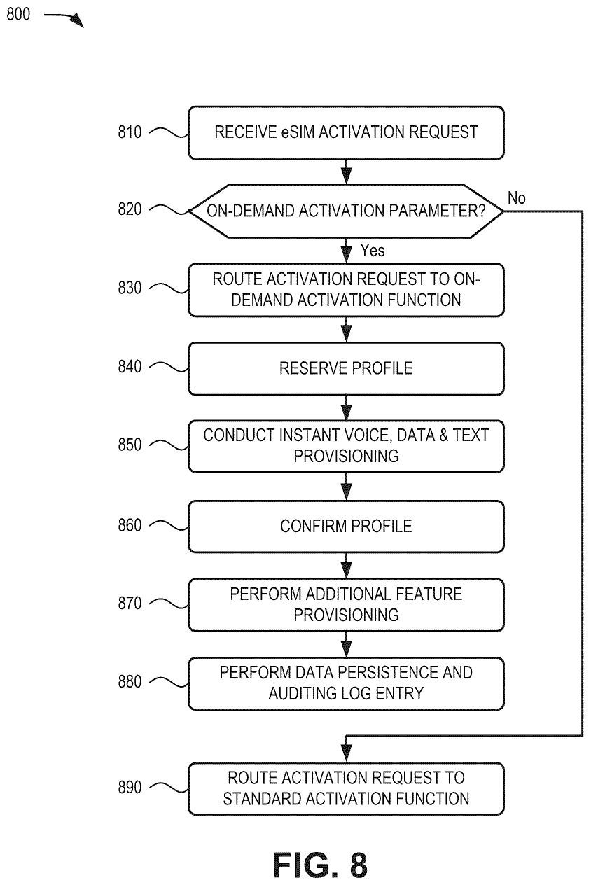

FIG. 8 is a flow chart of an exemplary process 800 for on-demand eSIM activation. In an embodiment, process 800 may be performed by eSIM activation platform 120. In other embodiments, process 800 may be performed by eSIM activation platform 120 in conjunction with one or more network devices in environment 100 and/or 200.

Process 800 may include receiving an eSIM activation request (block 810) and detecting if there is a valid on-demand activation parameter (block 820). For example, an ordering client 170 on UE device 110 may submit an activation request (e.g., activation request 505) to eSIM activation platform 120, based on input from a party at a point-of-sale location where UE device 110 is purchased. The activation request may include an indicator for on-demand activation, based on, for example, the purchase location or other information. eSIM activation platform 120 may receive the activation request and detect if there is an indicator for on-demand activation.

If there is a valid on-demand activation parameter (block 820—Yes), process 800 may include routing the activation request to an on-demand activation function (block 830) and reserving a profile (block 840), conducting VDT provisioning (block 850), and confirming a profile (block 860). For example, eSIM activation platform 120 (e.g., request route handler 240) may detect in the activation the request the indicator for on-demand activation and route the activation request to on-demand eSIM activation function 260. On-demand eSIM activation function 260 may perform processing/signaling to reserve a profile for the eSIM. Prior to, or simultaneously with, a confirmation process, on-demand eSIM activation function 260 may initiate VDT provisioning to activate essential or basic services for the UE device 110. Upon completion of the VDT provisioning and the confirmation process, eSIM activation platform 120 may provide to ordering client 170 a message indicating the eSIM activation and basic service activation are complete.

Process 800 may further include performing additional feature provisioning (block 870) and performing data persistence and auditing log entry as non-blocking processes (block 880). For example, after confirmation and VDT provisioning, provisioning system 130 may receive a provisioning request from ordering client 170 to provision non-essential or non-basic features. Provisioning system 130 may provide provisioning instructions to the various network elements 220 to support provisioning of the non-essential or non-basic features. Furthermore, eSIM activation platform 120 may perform logging and database updates related to the activation request and confirmation. The logging and database updates may be conducted outside the activation sequence as non-blocking processes that may be performed after activation of the features.

Returning to block 820, if there is not a valid on-demand activation parameter (block 820—No), process 800 may include routing the activation request to a standard activation function (block 890). For example, if the activation request from ordering client 170 does not include an indicator for on-demand activation, request route handler 240 may forward the activation request to standard eSIM activation function 250. Standard eSIM activation function 250 may follow an existing activation sequence, where eSIM profiles are reserved and confirmed after provisioning being initiated by a provisioning request from the ordering client 170.

FIG. 9 is a diagram illustrating exemplary components of a device 900 that may correspond to one or more of the devices described herein. For example, device 900 may correspond to components included in UE devices 110, eSIM activation platform 120, MNO provisioning system 130, and/or other elements illustrated in FIGS. 1 and 2. As illustrated in FIG. 9, according to an exemplary embodiment, device 900 includes a bus 905, one or more processors 910, memory/storage 915 that stores software 920, a communication interface 925, an input 930, and an output 935. According to other embodiments, device 900 may include fewer components, additional components, different components, and/or a different arrangement of components than those illustrated in FIG. 9 and described herein.

Bus 905 includes a path that permits communication among the components of device 900. For example, bus 905 may include a system bus, an address bus, a data bus, and/or a control bus. Bus 905 may also include bus drivers, bus arbiters, bus interfaces, and/or clocks.

Processor 910 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 910 may be implemented as hardware (e.g., a microprocessor, etc.), a combination of hardware and software (e.g., a SoC, an ASIC, etc.), may include one or multiple memories (e.g., cache, etc.), etc. Processor 910 may be a dedicated component or a non-dedicated component (e.g., a shared resource).

Processor 910 may control the overall operation or a portion of operation(s) performed by device 900. Processor 910 may perform one or multiple operations based on an operating system and/or various applications or computer programs (e.g., software 920). Processor 910 may access instructions from memory/storage 915, from other components of device 900, and/or from a source external to device 900 (e.g., a network, another device, etc.). Processor 910 may perform an operation and/or a process based on various techniques including, for example, multithreading, parallel processing, pipelining, interleaving, etc.

Memory/storage 915 includes one or multiple memories and/or one or multiple other types of storage mediums. For example, memory/storage 915 may include one or multiple types of memories, such as, random access memory (RAM), dynamic random-access memory (DRAM), cache, read only memory (ROM), a programmable read only memory (PROM), a static random-access memory (SRAM), a single in-line memory module (SIMM), a dual in-line memory module (DIMM), a flash memory (e.g., a NAND flash, a NOR flash, etc.), and/or some other type of memory. Memory/storage 915 may include a hard disk (e.g., a magnetic disk, an optical disk, a magneto-optic disk, a solid-state disk, etc.), a Micro-Electromechanical System (MEMS)-based storage medium, and/or a nanotechnology-based storage medium. Memory/storage 915 may store data, software, and/or instructions related to the operation of device 900.

Software 920 includes an application or a program that provides a function and/or a process. Software 920 may include an operating system. Software 920 is also intended to include firmware, middleware, microcode, hardware description language (HDL), and/or other forms of instruction. According to on example, ordering client 170 may be implemented as software 920 on UE device 110.

Communication interface 925 permits device 900 to communicate with other devices, networks, systems, devices, and/or the like. Communication interface 925 includes one or multiple wireless interfaces and/or wired interfaces. For example, communication interface 925 may include one or multiple transmitters and receivers, or transceivers (e.g., radio frequency transceivers). Communication interface 925 may include one or more antennas. For example, communication interface 925 may include an array of antennas. Communication interface 925 may operate according to a protocol stack and a communication standard. Communication interface 925 may include various processing logic or circuitry (e.g., multiplexing/de-multiplexing, filtering, amplifying, converting, error correction, etc.).

Input 930 permits an input into device 900. For example, input 930 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 935 permits an output from device 900. For example, output 935 may include a speaker, a display, a light, an output port, and/or some other type of visual, auditory, tactile, etc., output component. According to some embodiments, input 930 and/or output 935 may be a device that is attachable to and removable from device 900.

Device 900 may perform a process and/or a function, as described herein, in response to processor 910 executing software 920 stored by memory/storage 915. By way of example, instructions may be read into memory/storage 915 from another memory/storage 915 (not shown) or read from another device (not shown) via communication interface 925. The instructions stored by memory/storage 915 cause processor 910 to perform a process described herein. Alternatively, for example, according to other implementations, device 900 performs a process described herein based on the execution of hardware (processor 910, etc.).

Systems and methods provide an on-demand embedded subscriber identity module (eSIM) activation function that expedites the activation and provisioning process for user equipment (UE) devices. A network device receives, from a UE device, an activation request for an eSIM and detects, in the activation request, an activation parameter. When the activation parameter includes an on-demand activation indicator, the network device routes the activation request to an on-demand activation function, and initiates provisioning of basic wireless features for the UE device without receiving a provisioning request from the UE device.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIG. 8, and message flows with regard to FIGS. 5 and 6, the order of the blocks and messages may be modified in other embodiments. Further, non-dependent messaging and/or processing blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

The terms “comprises” and/or “comprising,” as used herein specify the presence of stated features, integers, steps or components but does not preclude the presence or addition of one or more other features, integers, steps, components, or groups thereof. Further, the term “exemplary” (e.g., “exemplary embodiment,” “exemplary configuration,” etc.) means “as an example” and does not mean “preferred,” “best,” or likewise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, by a network device and from a user equipment (UE) device, an activation request for an embedded subscriber identity module (eSIM);
detecting, in the activation request, an activation parameter; and
in response to detecting that the activation parameter includes an on-demand activation indicator:
routing the activation request to a first activation function, and
initiating provisioning of wireless features for the UE device without receiving a provisioning request from the UE device.

2. The method of claim 1, wherein initiating provisioning of the wireless features include initiating provisioning of voice, data, and text services for the UE device.

3. The method of claim 1, further comprising:
receiving a signal indicating provisioning of the wireless features is complete; and
sending, to the UE device, an eSIM activation confirmation message after receiving the signal.

4. The method of claim 3, further comprising:
receiving, by a provisioning system, a provisioning request for additional wireless features for the UE device after the first activation function sends the eSIM activation confirmation message.

5. The method of claim 1, further comprising, in response to determining the activation parameter includes the on-demand activation indicator:
sending, to an activation server, a reserve profile request;
receiving, from the activation server, a reserve response;
forwarding, to the UE device, a confirmation request; and
conducting logging and storing of the reserve profile request as non-blocking processes.

6. The method of claim 1, wherein initiating the provisioning of the wireless features includes sending instructions from the first activation function to a provisioning system.

7. The method of claim 1, wherein receiving the activation request includes:
receiving the activation request via a direct interfacing application programming interface (API).

8. The method of claim 1, further comprising:
routing the activation request to a second activation function, when the activation parameter does not include the on-demand activation indicator.

9. The method of claim 8, wherein the second activation function and the first activation function are included within an eSIM activation platform.

10. A network device, comprising:
a processor configured to:
receive, from a user equipment (UE) device, an activation request for an embedded subscriber identity module (eSIM);
detect, in the activation request, an activation parameter; and
in response to detecting that the activation parameter includes an on-demand activation indicator:
route the activation request to a first activation function, and
initiate provisioning of wireless features for the UE device without receiving a provisioning request from the UE device.

11. The network device of claim 10, wherein the wireless features include voice, data, and text services for the UE device.

12. The network device of claim 10, wherein the processor is further configured to:
receive a signal indicating provisioning of the wireless features is complete; and
send, to the UE device, an eSIM activation confirmation message after receiving the signal.

13. The network device of claim 10, wherein, when the activation parameter includes the on-demand activation indicator, the processor is further configured to:
send, to an activation server, a reserve profile request;
receive, from the activation server, a reserve response;
forward, to the UE device, a confirmation request; and
conduct logging and storing of the reserve profile request as non-blocking processes.

14. The network device of claim 10, wherein, when initiating the provisioning of the wireless features, the processor is further configured to:
send instructions from the first activation function to a provisioning system.

15. The network device of claim 10, wherein, when receiving the activation request, the processor is further configured to:
receive the activation request via an application programming interface (API), without queuing the activation request.

16. The network device of claim 10, wherein the processor is further configured to:
route the activation request to a second activation function when the activation parameter does not include the on-demand activation indicator.

17. A non-transitory computer-readable medium comprising instructions, which, when executed by a processor of a network device, cause the processor to:
receive, from a user equipment (UE) device, an activation request for an embedded subscriber identity module (eSIM);
detect, in the activation request, an activation parameter; and
in response to detecting that the activation parameter includes an on-demand activation indicator:
route the activation request to a first activation function, and
initiate provisioning of wireless features for the UE device without receiving a provisioning request from the UE device.

18. The non-transitory computer-readable medium of claim 17, wherein, when initiating the provisioning of the wireless features, the instructions further cause the processor to:
send instructions from the first activation function to a provisioning system.

19. The non-transitory computer-readable medium of claim 17, further including instructions to cause the processor to:
route the activation request to a second activation function when the activation parameter does not include an on-demand activation indicator.

20. The non-transitory computer-readable medium of claim 17, wherein, when the activation parameter includes the on-demand activation indicator, the instructions further cause the processor to:
send, to an activation server, a reserve profile request;
receive, from the activation server, a reserve response;
forward, to the UE device, a confirmation request; and
conduct logging and storing of the reserve profile request as non-blocking processes.
